(19) United States
(12) Patent Application Publication
(10) Pub. No.: US 2007/0110014 A1
(43) Pub. Date: May 17, 2007

(54) Data transfer apparatus, data transferring method, and data transfer program

(75) Inventor: Ryo Mizuguchi, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/360,507

(22) Filed: Feb. 24, 2006

(30) Foreign Application Priority Data
Nov. 17, 2005 (JP) 2005-333205

(51) Int. Cl. H04Q 7/24

(52) U.S. Cl. 370/338

(57) ABSTRACT

Various data such as mail data distributed through network are transferred to a communication terminal device through the medium of a non-contact IC card communication technology, and the transfer data are enabled to be viewed with a communication terminal device separated from the network. A data transfer apparatus (NW device 10) transferring received data from network 8 is constituted by including a data receiving unit (mail receiving unit 38) that receives data through the network and a non-contact communication unit 14 writes the received data into a non-contact IC card of a communication terminal device (cellular phone 12) equipped with the non-contact IC card (non-contact IC card chip 58) into which data can be written wirelessly.

### CROSS-REFERENCE TO RELATED APPLICATIONS

This application is based upon and claims the benefit of priority from the prior Japanese Patent Application No. 2005-333205, filed on Nov. 17, 2005, the entire contents of which are incorporated herein by reference.

### BACKGROUND OF THE INVENTION

1. Field of the Invention

The present invention relates generally to reception of data such as a mail transmitted through network such as the Internet, and more particularly, to a data transfer apparatus, data transferring method, data transfer program, communication terminal device, and data transfer system for transferring received data of a network device linked to network to a communication terminal device such as a cellular phone with the use of a short-range communication function of a non-contact IC (Integrated Circuit) card, for example.

2. Description of the Related Art

With regard to communication of various data such as mails distributed through the internet, various data such as mails can be received and checked by a communication terminal device such as a personal computer and a cellular phone connected to network. With regard to such data communication, technologies for simplifying mail checking is known as, for example, a technology notifying an incoming mail (Japanese Patent Application Laid-Open Publication No. 2004-272478), a technology performing non-contact communication with electromagnetic waves between a cellular phone and a personal computer with the use of a non-contact IC card (Japanese Patent Application Laid-Open Publication No. 2003-32175), a technology writing a medium ID into an e-mail for an external connection apparatus used when registering the medium ID (Identification) of a recording medium into an information distribution apparatus (Japanese Patent Application Laid-Open Publication No. 2004-178100), etc.

By the way, even with the technology simplifying the checking of an incoming mail in Japanese Patent Application Laid-Open Publication No. 2004-272478, an information device such as a personal computer is necessary and is needed to be operated to actually read the mail. Japanese Patent Application Laid-Open Publication No. 2003-32175 merely discloses that a card ID of a non-contact IC card is notified to a personal computer when electromagnetic waves radiated from a reader/writer is received by the non-contact IC card by locating a cellular phone in close vicinity to the personal computer. Japanese Patent Application Laid-Open Publication No. 2004-178100 merely discloses that a tag ID of an IC tag is attached to a mail for communication. Even in a network device such as a broad-band router and a modem, to check content of an incoming mail, a personal computer must be operated to deploy the mail on a screen, which is a troublesome operation for a user. By separating the mail reception from the mail checking, the convenience of e-mails may be enhanced.

In Japanese Patent Application Laid-Open Publication Nos. 2004-272478, 2003-32175, and 2004-178100, such a problem is not disclosed, and configuration for solving the problem is not disclosed or indicated.

### SUMMARY OF THE INVENTION

It is therefore the object of the present invention to improve the degree of freedom of data transfer with the aid of a communication function of a non-contact IC card, with regard to communication of various data such as mail data distributed through network.

To this end, various data such as mail data distributed through network are transferred to a communication terminal device through the medium of a non-contact IC card communication technology, and the transfer data are enabled to be viewed with a communication terminal device separated from the network.

In order to achieve the above object, according to a first aspect of the present invention there is provided a data transfer apparatus that transfers received data from network, the apparatus comprising a data receiving unit that receives data through the network; and a non-contact communicating unit that writes the received data into a non-contact IC card of a communication terminal device equipped with the non-contact IC card into which data can be written wirelessly.

The data received by the data receiving unit from the network is transferred to the non-contact IC card by establishing the communication between the non-contact communicating unit and the non-contact IC card of the communication terminal device.

Preferably, the data transfer apparatus may comprise a transfer destination determining unit that establishes the communication between the non-contact communicating unit and the non-contact IC card to determine with authentication data received from the communication terminal device whether or not the communication terminal device is the transfer destination of the received data.

Preferably, the data transfer apparatus may comprise a processing unit that correlates registration information identifying the data transfer destination through the network with identification information identifying the communication terminal device to sort the data by the identification information.

Preferably, the data transfer apparatus may comprise a communication controlling unit that is connected to a data distribution source through the network, the communication controlling unit fetching data periodically through the network; and a data accumulating unit that accumulates the data fetched by the communication controlling unit.

Preferably, the data transfer apparatus may comprise a data modifying unit that removes unnecessary data from the received data of the data receiving unit for modification into transfer data.

The data transfer apparatus may comprise a data modifying unit that divides the received data of the data receiving unit into units of the size that can be transferred to the non-contact IC card for modification into the transfer data.

To achieve the above object, according to a second aspect of the present invention there is provided a data transferring method that transfers received data from network, the method comprising the operations of receiving data with a data receiving unit through the network; establishing communication with a non-contact IC card into which data can be written wirelessly, the non-contact IC card being equipped in a communication terminal device of the transfer destination of the data; and writing the received data of the data receiving unit into the non-contact IC card.

The received data are transferred by receiving the data with the data receiving unit from the network, by establishing the communication between the non-contact communicating unit and the non-contact IC card of the communication terminal device, and by writing the received data into the non-contact IC card.

Preferably, the data transferring method may comprise the operations of establishing the communication between a non-contact communicating unit and the non-contact IC card; and determining with authentication data received from the communication terminal device whether or not the communication terminal device is the transfer destination of the received data.

Preferably, the data transferring method may comprise the operation of correlating registration information determining the data transfer destination through the network with identification information identifying the communication terminal device.

Preferably, the data transferring method may comprise the operations of receiving data periodically from a data distribution source through the network; and accumulating the received data.

Preferably, the data transferring method may comprise the operation of removing unnecessary data from the received data for modification into transfer data.

Preferably, the data transferring method may comprise the operation of dividing the received data into units of the size that can be transferred for modification into the transfer data.

To achieve the above object, according to a third aspect of the present invention there is provided a data transfer program that is executed by a computer to transfer data received through network, the program comprising the steps of receiving data through the network; establishing communication with a non-contact IC card into which data can be written wirelessly, the non-contact IC card being equipped in a communication terminal device of the transfer destination of the data; and writing the received data into the non-contact IC card.

The received data are transferred by executing the program with the computer to receive the data with the data receiving unit from the network, to establish the communication between the non-contact communicating unit and the non-contact IC card of the communication terminal device, and to write the received data into the non-contact IC card.

Preferably, the data transfer program may comprise the steps of establishing the communication between a non-contact communicating unit and the non-contact IC card; and determining with authentication data received from the communication terminal device whether or not the communication terminal device is the transfer destination of the received data.

Preferably, the data transfer program may comprise the step of correlating registration information determining the data transfer destination through the network with identification information identifying the communication terminal device.

Preferably, the data transfer program may comprise the steps of receiving data periodically from a data distribution source through the network; and accumulating the received data.

Preferably, the data transfer program may comprise the step of removing unnecessary data from the received data for modification into transfer data.

Preferably, the data transfer program may comprise the step of dividing the received data into units of the size that can be transferred for modification into the transfer data.

The features and advantages of the present invention are listed as follows.

(1) Since data are received from network and the data are transferred from the data transfer apparatus to the communication terminal device through the intervention of the non-contact communication, the communication processing between the communication terminal device and the network can be reduced and the timing of the data reception can be arbitrarily set by the communication terminal device.

(2) For example, if mail data are used for data acquisition, since the non-contact communication exists between the data transfer apparatus and the communication terminal device, the mail data can be viewed without the communication terminal device needing to be connected through a line such as a public line, which is economical.

Other objects and advantages of the present invention will become more apparent from the following description of the preferred embodiments when taken in conjunction with the accompanying drawings.

### BRIEF DESCRIPTION OF THE DRAWINGS

FIG. 1 is a diagram showing a mail-data transfer system;

FIG. 2 is a diagram showing a configuration example of a network device;

FIG. 3 is a diagram showing a configuration example of a cellular phone;

FIG. 4 is a diagram showing a configuration example of a non-contact IC card reader/writer unit;

FIG. 5 is a diagram showing a configuration example of a non-contact IC card chip;

FIG. 6 is a diagram showing a link processing among a mail server, NW device, and cellular phone;

FIG. 7 is a flowchart showing environment setting processing of the NW device;

FIG. 8 is a flowchart showing data link processing of the NW device;

FIG. 9 is a flowchart showing a mail-data division processing subroutine;

FIGS. 10A to 10C are diagrams showing unnecessary-data deletion processing of the mail data;

FIGS. 11A to 11D are diagrams showing mail-data division processing;

FIG. 12 is a flowchart showing data link processing of the cellular phone;

FIG. 13 is a diagram showing a message representing that non-contact communication is in process;

FIG. 14 is a diagram showing a message notifying of a failure of data reading;

FIG. 15 is a message representing whether a mail exists or not;

FIG. 16 is a diagram showing a message representing that data transfer is in process;

FIG. 17 is a flowchart of authentication processing;

FIG. 18 is a diagram showing an authentication screen;

FIG. 19 is a diagram showing a message representing that the divided mail data still exist;

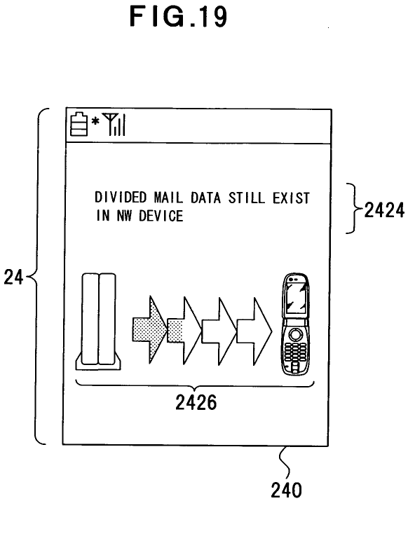

FIG. 20 is a flowchart showing a variation of the data link processing in the NW device;

FIG. 21 is a diagram showing a variation of the mail-data transfer system;

FIG. 22 is a diagram showing a variation of the mail-data transfer system; and

FIG. 23 is a diagram showing a variation of the mail-data transfer system.

### DETAILED DESCRIPTION OF THE PREFERRED EMBODIMENTS

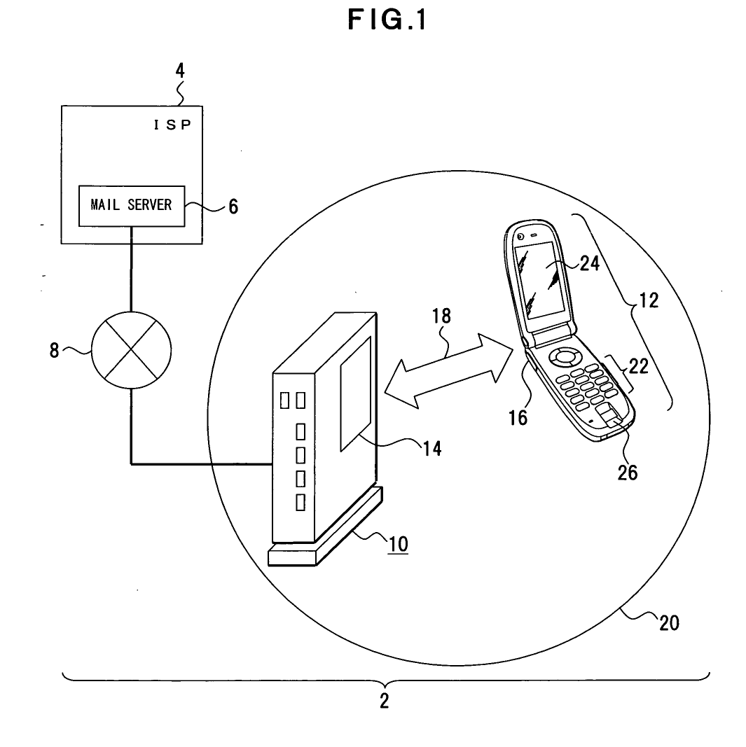

Description will be made of embodiments of a data transfer apparatus, data transferring method, data transfer program, communication terminal device, and data transfer system according to the present invention with reference to FIG. 1. FIG. 1 shows a mail-data transfer system.

As an example of a data transfer system, a mail-data transfer system 2 is constituted by: a network device (hereinafter, “NW device”) as a data transfer apparatus or data reception apparatus connected through network 8 to a mail server 6 of an internet service provider (ISP) 4, which is a distribution source of mail data, etc.; and for example, a cellular phone 12 as a communication terminal device, which is a data transfer destination receiving data transfer from this NW device 10. The NW device 10 constitutes a data reception apparatus because the NW device 10 receives data through the network 8 as well as constitutes a data transfer apparatus because the NW device 10 transfers the received data.

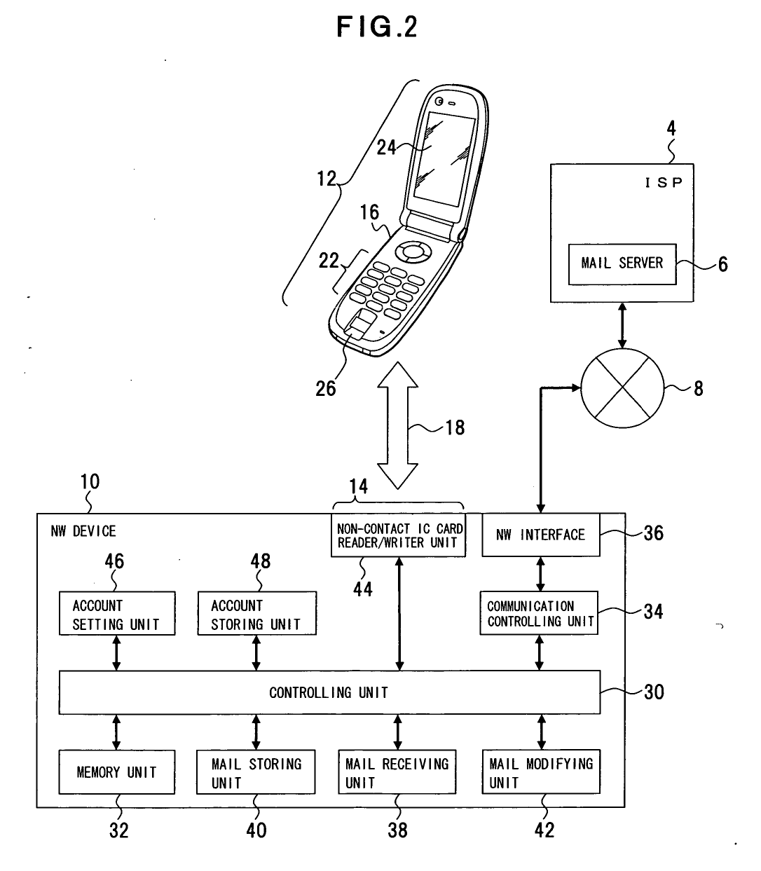

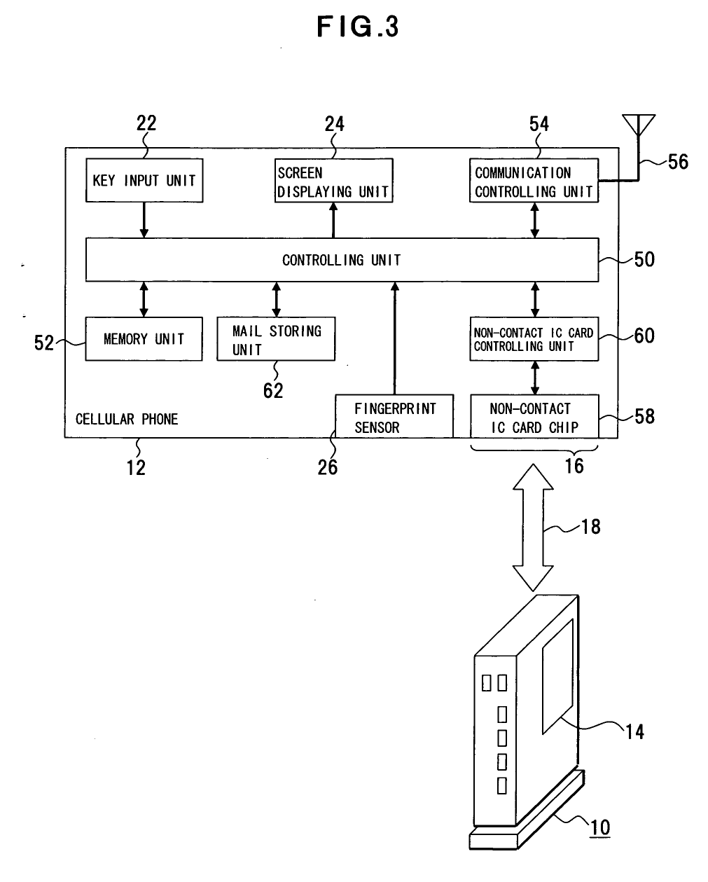

The NW device 10 is constituted by, for example, a broadband router, a modem, a wireless LAN (Local Area Network) station, a personal computer, etc. as a device with a function transmitting/receiving data linked to the network 8 as well as is provided with a non-contact communicating unit 14 composed of, for example, a non-contact IC (Integrated Circuit) card, etc. as RFID that achieves data transfer individually without using a public line, and the non-contact communicating unit 14 is constituted by a non-contact IC card reader/writer unit 44 (FIG. 2) described later, for example. The cellular phone 12 is provided with a non-contact communicating unit 16 corresponding to the non-contact communicating unit 14 and the non-contact communicating unit 16 is constituted by a non-contact IC card chip 58 (FIG. 3) described later, for example. According to the non-contact communication technology utilizing such a non-contact IC card technology, when the cellular phone 12 enters into a limited communicable area 20 where electric waves 18 transmitted from the non-contact communicating unit 16 can be received, communication is established with the NW device 10 and the data transfer can be performed for mail data, etc.

The cellular phone 12 is provided with a key input unit 22, a screen displaying unit 24, etc. as well as a fingerprint sensor 26 used for determining and identifying a user.

In this mail-data transfer system 2, the data transfer and the security maintenance are performed as follows.

(1) The NW device 10 periodically accesses to a mail box set in the mail server 6 of the ISP 4 to check an incoming mail and if a mail exists, the mail is fetched to be accumulated in the NW device 10.

(2) When the cellular phone 12 enters into the communicable area 20 of the NW device 10 and is, for example, held up, non-contact communication is established with the NW device 10 wirelessly. User identification information is transmitted from the cellular phone 12 to the NW device 10 through the non-contact communication. The user identification information may be constituted by a unique number of the non-contact IC card chip.

(3) The NW device 10 checks whether or not mail reception data are written into an account corresponding to the user identification information received from the cellular phone 12, which is a data transfer destination of the mail, etc.

(4) Before the cellular phone 12 refers to the mail, authentication of a user may be performed. If the authentication is set, a password is input from the key input unit 22; a fingerprint input from the fingerprint sensor 26 is authenticated; and only when the authentication succeeds, communication for acquiring the mail is performed to enable to fetch and refer to the mail reception data. As a result, if the cellular phone 12 is used by someone else without permission, the mail is prevented from being viewed.

Description will be made of the NW device and the cellular phone with reference to FIGS. 2 and 3. FIG. 2 is a diagram showing an example of the NW device and FIG. 3 is a diagram showing an example of the cellular phone. In FIGS. 2 and 3, the same numerals are added to the same portions as FIG. 1.

The NW device 10 is constituted by a computer, is connected with a mail server 6 through the network 8, and is provided with various functions such as a data transmission/reception function for the mail data, an accumulation function for the received mail data, a non-contact communication function using the non-contact IC card, a modification function for the mail data, and an account function maintaining the linkage relationship with the cellular phone 12. To achieve such functions, as shown in FIG. 2, the NW device 10 is provided with a controlling unit 30, a memory unit 32, a communication controlling unit 34, a network (NW) interface 36, a mail receiving unit 38 as an example of a data receiving unit, a mail storing unit 40 as an example of a data storing unit or data accumulating unit, a mail modifying unit 42 as an example of a data modifying unit, a non-contact IC card reader/writer unit 44 of the non-contact communicating unit 14, an account setting unit 46, an account storing unit 48, etc.

In the NW device 10, the controlling unit 30 is constituted by a CPU (Central Processing unit), etc. and executes a data transfer program, etc. to perform processing of the aforementioned various functions including search/determination of a data transfer destination, data transfer, etc. to constitute a data processing unit, a data transfer determining unit, etc. The memory unit 32 is a recording medium storing various programs such as the aforementioned data transfer program and a non-contact communication processing program. The communication controlling unit 34 is connected to the network 8 through the NW interface 36 and controls the connection with the mail server 6 of the ISP 4. In this embodiment, the NW device 10 is connected to the mail server 6 to fetch mail data periodically, and the mail data are fetched into the mail receiving unit 38. The received mail data are stored and saved in the mail storing unit 40. With regard to the received mail data, the mail modifying unit 42 deletes unnecessary data in the mail data and divides the mail data into the size that can be transmitted by the non-contact IC card reader/writer unit 44. The deletion of the unnecessary data in the mail data is the processing for the data transfer using the non-contact IC card reader/writer unit 44, and the unnecessary data are information in a mail header of a received mail except a title, a sender, a destination, and a transmission time as well as an attached file.

The non-contact IC card reader/writer unit 44 transmits/receives the electric waves 18 to/from the non-contact communicating unit 16 of the cellular phone 12 and transmits the transfer data to the non-contact communicating unit 16. The account setting unit 46 is used for a user setting a mail server address, a user account, a password, etc. and the set account is stored and saved in the account storing unit 48.

The cellular phone 12 is an example of the communication terminal device and is constituted by a computer. The cellular phone 12 is provided with various functions such as a telephone communication function, a non-contact communication function using the non-contact IC card, and a user authentication function. To achieve such functions, as shown in FIG. 3, the cellular phone 12 is provided with a controlling unit 50, a memory unit 52, a communication controlling unit 54, an antenna 56, a non-contact IC card chip 58 of the non-contact communicating unit 16, a non-contact IC card controlling unit 60, a mail storing unit 62, and the aforementioned key input unit 22, the screen displaying unit 24, and the fingerprint sensor 26.

In the cellular phone 12, the controlling unit 50 is constituted by the aforementioned CPU, etc. and executes processing of various functions such as a communication function for receiving the transfer data, a telephone communication function using a public line, and a screen display program. The memory unit 52 is a recording medium storing various programs such as a non-contact communication processing program corresponding to the aforementioned data transfer program, a mail reception program, and a user authentication program as well as biological data such as fingerprint data and authentication data such as a password. The communication controlling unit 54 is connected to a public telephone line wirelessly and is provided with the antenna 56 for transmitting/receiving the electric waves 18.

The non-contact IC card chip 58 is controlled by the non-contact IC card controlling unit 60 to transmit/receive the electric wave 18 to/from the non-contact communicating unit 14 of the NW device 10 and to receive the transfer data from the NW device 10. The transfer data are stored and saved in the mail storing unit 62.

The fingerprint sensor 26 is used to input a fingerprint for fingerprint authentication of a user, and the key input unit 22 is used to input a password, a telephone number, etc. The screen displaying unit 24 is constituted by an LCD (Liquid Crystal Display), etc. and used to display the input information and various messages.

With regard to the mail-data transfer system 2 provided with the NW device 10 and the cellular phone 12, the function and the operation is as follows.

In the mail-data transfer system 2, the NW device 10 constitutes a server for the cellular phone 12; the mail data are fetched and accumulated to the NW device 10 from the mail server 6; and when entering into the communicable area 20 of the NA device 10, the cellular phone 12 receives the transfer of the mail data from the NW device 10 and enables the mail to be read.

To enable such data transfer, the environment setting must be performed for the NW device 10 and the cellular phone 12. For example, the mail server address, the user account, and the password are set as registration information in the NW device 10. To link the registration information, i.e., the account set in the NW device 10 with the cellular phone 12, the non-contact communication of the NW device 10 is established. By establishing the communication, for example, the unique number added to the non-contact IC card chip 58 is notified to the NW device 10 as the identification information of the cellular phone 12, and the unique number is made correspond to the account. That is, the registration information of the user of the NW device 10 is made correspond to the identification information to enable the mail distributed from the mail server 6 to be transferred to the cellular phone 12.

The NW device 10 constituting a server periodically acquires the mail from the mail server 6 and the acquired mail is accumulated and saved in the mail storing unit 40. Such mail acquisition may be configured such that when the cellular phone 12 enters into the communicable area and the action is performed for establishing the communication, the NW device 10 acquires the mail. That is, when the mail acquisition of the NW device 10 and the data transfer to the cellular phone 12 are asynchronous, the waiting time of the user can be shortened. If the mail acquisition processing is started for the mail server 6 when the non-contact IC card chip 58 of the cellular phone 12 is held up toward the non-contact communicating unit 14 of the NW device 10, time is spent for the processing of the mail acquisition, the mail division, the transfer thereof, etc., which makes the waiting time of the user long, and therefore, to prevent this situation, the NW device 10 periodically acquires and accumulates the mail into the mail storing unit 40 in preparation for the data transfer to the cellular phone 12 to achieve the reduction of the user waiting time.

The NW device 10 deletes unnecessary data from the received mail data to achieve the reduction of the transfer data amount. As described above, by removing the data in the mail header of the received mail except a title, a sender, a destination, and a transmission date/time, since the data size is reduced, the data transfer can be supported even when the data transfer amount of the non-contact communication is constrained and the reduction of the communication time can also be achieved.

The mail data must be a size equal to or less than the data amount that can be delivered in one non-contact communication. Therefore, the mail data received by the NW device 10 from the mail server 6 are divided into the size that can be transferred and are stored in the data area of the mail storing unit 40 as divided mail data. In this case, a mail-data management area in the storage data stores record data indicating that the divided mail data exist.

With regard to the NW device 10 and the cellular phone 12, by the NW device 10 acquiring the unique number of the non-contact IC card chip 58 of the cellular phone 12 through the communication between the non-contact IC card reader/writer unit 44 and the non-contact IC card chip 58, the linkage relationship between the NW device 10 and the cellular phone 12 is maintained, and it is known that a certain mail is transferred to the cellular phone 12, i.e., the transfer destination of the mail data. After the mail data are transferred to the cellular phone 12, i.e., the certain transfer destination, by erasing and destroying the transfer data in the NW device 10, the data area of the mail storing unit 40 can be prevented from being occupied. By repeating the mail-data transfer to the cellular phone 12 through the non-contact communication, the erasing of the transferred data, and the fetch of mail data from the mail server 6, the data transfer can be performed by a data area with a limited data amount for a large amount of data much greater than that data amount.

The cellular phone 12 starts the non-contact communication when the cellular phone 12 enters into the vicinity, i.e., the communicable area 20 of the NW device 10. The mail data are recognized from the data format of the transfer data, which triggers the activation of the aforementioned mail reception program and the fetch of the mail data. The mail data are stored and saved in the data area of the mail storing unit 62. With regard to the relationship between the fetch of the mail data and the incoming phone call of the cellular phone 12, if a phone call is received during the fetch of the mail data, for example, the cellular phone 12 may indicate that the mail data are being fetched and may give priority to the fetch of the mail data or may be configured such that the fetch of the mail data is discontinued to give priority to the incoming call and the telephone call.

If the user authentication such as password or biometrics authentication is performed before the fetch of the mail data into the cellular phone 12 and if the mail data can be acquired only when the authentication succeeds, unauthorized access from individuals other than the registered user can be prevented.

The mail data fetched into the cellular phone 12 is deployed and displayed on the screen displaying unit 24 by executing the aforementioned screen display program. As the management information of the received data, it is notified that the data should be received successively, by displaying an icon, etc. on the screen displaying unit 24 along with a message representing that the divided mail data remain in the NW device 10. By checking the display, the user can maintain the state of the data transfer from the NW device 10, and the data transfer can be prevented from being discontinued.

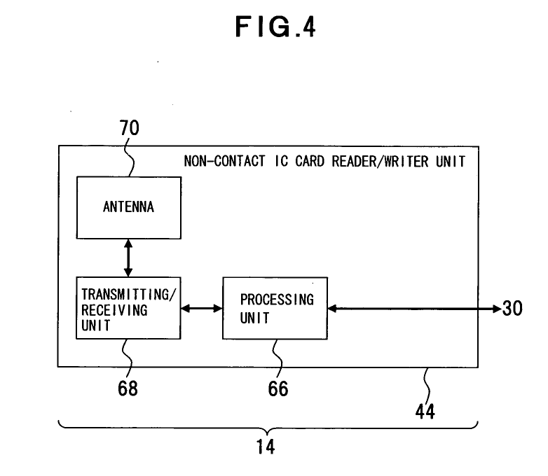

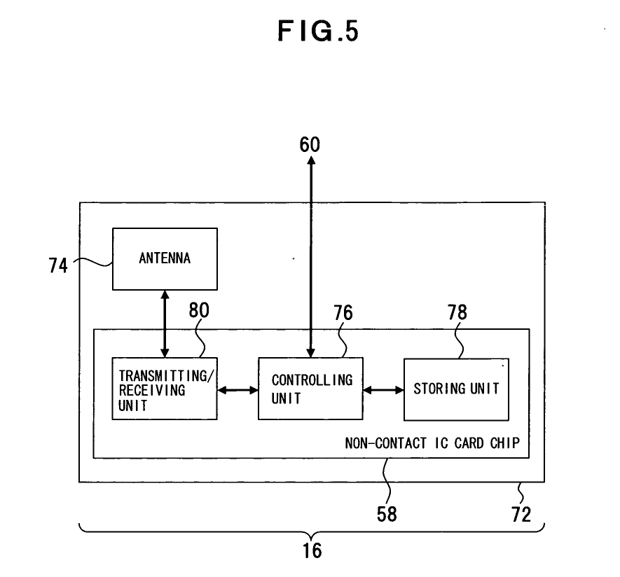

The non-contact communicating unit will be described with reference to FIG. 4 and FIG. 5. FIG. 4 is a diagram showing an example of the non-contact communicating unit of the NW device and FIG. 5 is a diagram showing an example of the non-contact communicating unit of the cellular phone.

The non-contact IC card reader/writer unit 44 installed in the non-contact communicating unit 14 of the NW device 10 is provided with a processing unit 66, a transmitting/receiving unit 68, and an antenna 70, as shown in FIG. 4. The transmitting/receiving unit 68 performs transmission and reception through the antenna 70 using the electric waves 18 with a certain frequency. The processing unit 66 outputs the transfer data such as the divided data of the mail data fetched from the mail server 6, and the transfer data are transmitted to the non-contact communicating unit 16 of the cellular phone 12 from antenna 70 after modulation processing, etc. by the transmitting/receiving unit 68.

As shown in FIG. 5, in the non-contact communicating unit 16, a substrate 72 is equipped with the non-contact IC card chip 58 and the antenna 74, and the non-contact IC card chip 58 is constituted by a controlling unit 76, a storing unit 78, and a transmitting/receiving unit 80. The transmitting/receiving unit 80 transmits and receives the electric waves 18 with a certain frequency through the antenna 74. The controlling unit 76 notifies the transmitting/receiving unit 80 of the identification information such as the unique number added to the non-contact IC card chip 58, controls the transmission and reception by the transmitting/receiving unit 80, and stores/reads each piece of information to/from the storing unit 78. The storing unit 78 stores the identification information such as the aforementioned unique number, programs, etc.

Between such a non-contact IC card reader/writer unit 44 and the non-contact IC card chip 58, the non-contact communication is performed through the electric waves 18, and the aforementioned transfer data are transmitted and received in the linkage relationship between the both due to the identification information.

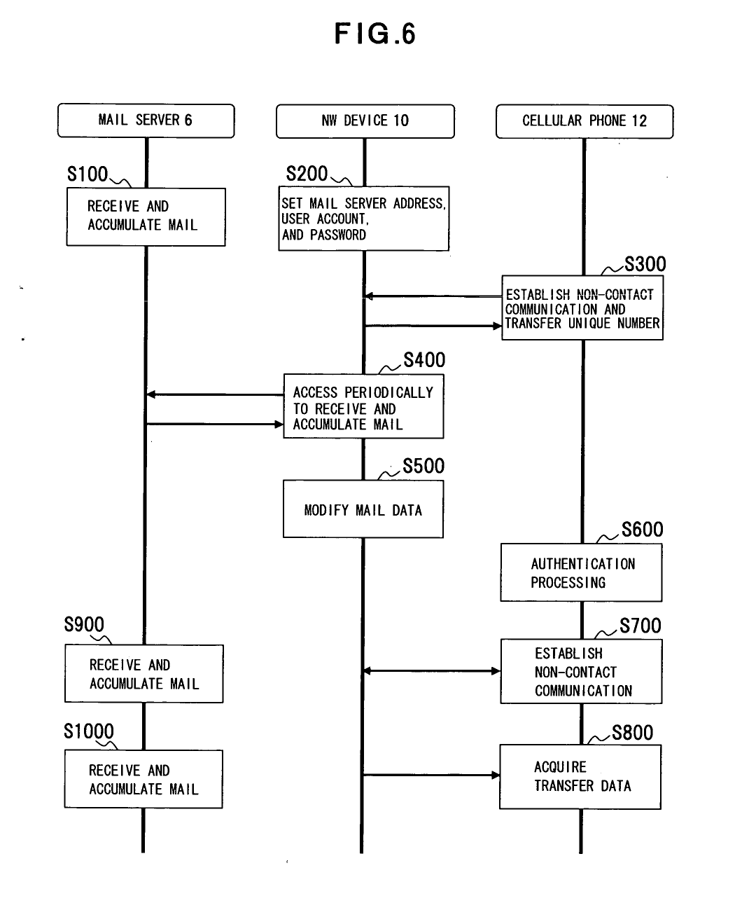

Description will be made of the linkage relationship among the mail server 6, the NW device 10, and the cellular phone 12 with reference to FIG. 6. FIG. 6 is a sequence diagram showing the linkage processing among the mail server 6, the NW device 10, and the cellular phone 12.

The mail server 6 receives a mail distributed through the network 8 and accumulates the mail (step S100). A user sets a mail server address, a user account, and a password in the NW device 10 (step S200). To link this NW device 10 and the cellular phone 12, i.e., the transfer destination of the mail data, the non-contact communication is established and the unique number of the non-contact IC card chip 58 is transferred from the cellular phone 12 to the NW device 10 (step S300). In this way, the registration information of the NW device 10 is made correspond to the identification information of the cellular phone 12, and the conditions are satisfied for receiving the transfer data from the NW device 10 in the cellular phone 12.

After establishing such a correlation, the NW device 10 periodically accesses to the mail server 6 to receive the mail accumulated in the mail server 6, which is stored in the mail storing unit 40 of the NW device 10 (step S400). For the acquired mail data, the aforementioned unnecessary data are removed, and data modification is performed for dividing the data into the size that can be transmitted through the non-contact communication, for example (step S500).

The cellular phone 12 performs the authentication processing as preprocessing before receiving the transfer data (step S600), establishes the non-contact communication between the NW device 10 and the cellular phone 12 by the cellular phone 12 entering into the communicable area 20 of the NW device 10 (step S700), and obtains the transfer data from the NV device 10 (step S800).

The mail server 6 repeats the mail reception and accumulation (step S900, S1000, . . . ), and correspondingly, the NW device 10 receives the mails through the periodic access and the processing from step S600 to S800 is performed in the cellular phone 12.

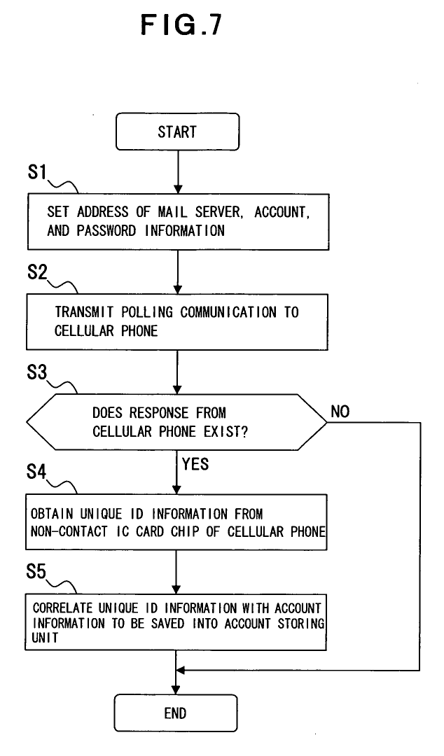

Description will be made of the environment setting of the NW device 10 with reference to FIG. 7. FIG. 7 is a flowchart showing the processing procedure of the environment setting of the NW device.

The environment setting processing is performed to enable the communication between the mail server 6 and the NW device 10. Therefore, in the NW device 10, identification information is set, such as an address, an account, a password, etc. of the mail server 6 (step S1). With such setting, the mail server 6 and the NW device 10 are enabled to communicate and a mail can be received from the mail server 6. After this setting, polling communication is transmitted from the NW device 10 to the cellular phone 12 (step S2). It is determined whether or not the cellular phone 12 responds to this polling communication (step S3), and if the cellular phone 12 does not respond (step S3, NO), the setting processing is terminated.

If the cellular phone 12 responds (step S3, YES), unique ID information is obtained from the non-contact IC card chip 58 of the cellular phone 12 (step S4). This unique ID information is unique information stored in the non-contact IC card chip 58 and is constituted by a unique number, for example. The NW device 10 correlates the unique ID information obtained from the cellular phone 12 with the account information, saves these pieces of information into the account storing unit 48, and terminates this processing.

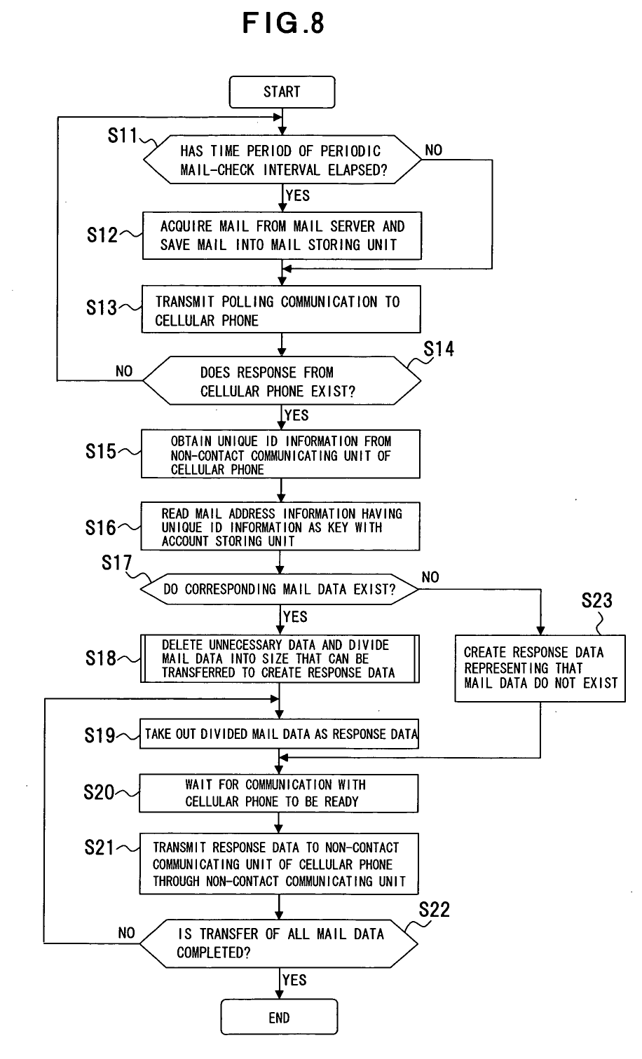

Description will be made of the data linkage processing of the NW device 10 with reference to FIG. 8. FIG. 8 is a flowchart showing the processing procedure of the data linkage processing of the NW device 10.

The NW device 10 is provided with a periodic mail-check function that checks whether or not mail information arrives at the mail server 6, and the mail check is performed at predetermined time intervals. Therefore, the NW device 10 determines whether a time period of the periodic mail-check interval has elapsed or not (step S11), and if the time period has been elapsed (step S11, YES), the NW device 10 acquires a mail from the mail server 6 and saves the acquired mail in the mail storing unit 40 (step S12). After this mail acquisition, polling communication is transmitted to the cellular phone 12 (step S13). If the time period of the periodic mail-check interval has not elapsed (step S11, NO), the polling communication is transmitted to the cellular phone 12 (step S13).

After this polling communication, it is determined whether the cellular phone 12 responds or not (step S14); if the cellular phone 12 does not respond (step S14, NO), the procedure goes back to step S11; and if the cellular phone 12 responds (step S14, YES), unique ID information is obtained from the non-contact communicating unit 16 of the cellular phone 12 (step S15).

This unique ID information is used for reading mail address information, and the mail address information having the unique ID information as a key is read (step S16). It is determined whether corresponding mail data exist or not (step S17), and if the mail data exist (step S17, YES), after the unnecessary data are deleted, the mail data are divided into the size that can be transferred to generate the response data as the transfer data (step S18) and the divided mail data are took out as the response data (step S19).

The NW device 10 waits for the communication with the cellular phone 12 to be ready (step S20), and if the communication is ready, the response data are transmitted to the non-contact communicating unit 16 of the cellular phone 12 through the non-contact communicating unit 14 (step S21). after the start of the communication, it is determined whether the transfer of all the divided mail data is completed or not (step S22), and if the transfer is not completed (step S22, NO), the processing from step S19 to S22 is repeated to continue the transmission until the transfer of all the divided mail data is completed. If the transfer of all the divided mail data is completed (step S22, YES), the data linkage processing is completed.

If the corresponding mail data do not exist (step S17, NO), response data are generated to represent that the mail data do not exist (step S23), and the response data are transmitted to the non-contact communicating unit 16 of the cellular phone 12 through the non-contact communicating unit 14 after the communication is ready (steps S20, S21).

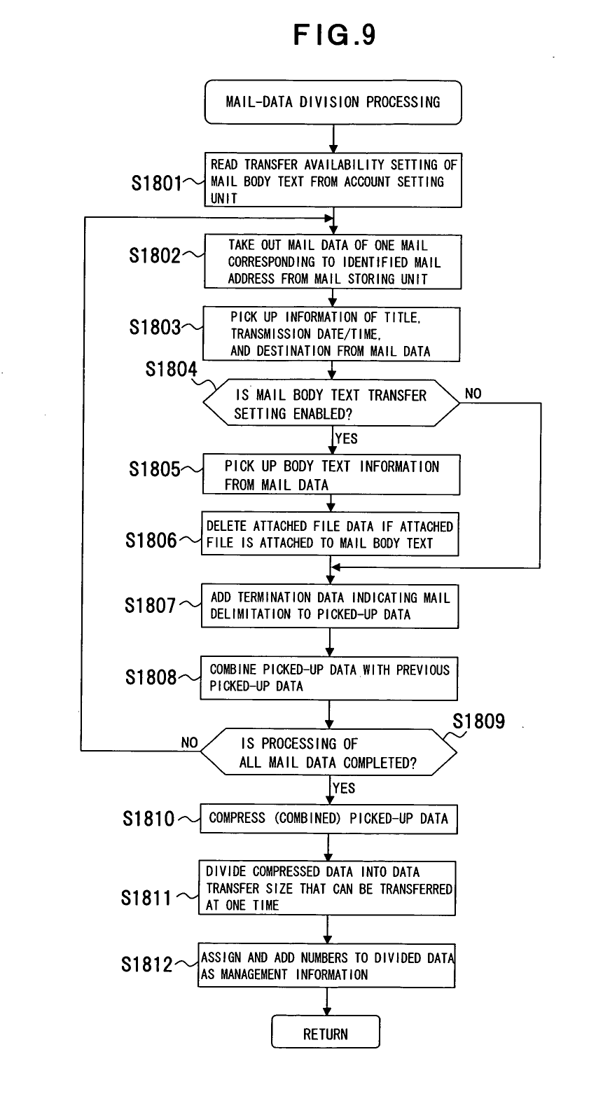

Description will be made of the mail-data division processing (step S18 of FIG. 8) with reference to FIG. 9. FIG. 9 is a flowchart showing a processing procedure of a mail-data division processing subroutine.

When the mail-data division processing is started, transfer availability setting of a mail body text is read from the account setting unit 46 of the NW device 10 (step S1801); mail data of one mail corresponding to the identified mail address are took out from the mail storing unit 40 (step S1802); information of a title, transmission date/time, and destination of the mail is picked up from the mail data (step S1803).

It is determined whether the mail body text transfer setting is enabled or not (step S1804), and if the transfer setting is enabled (step S1804, YES), the body text information is picked up from the mail data (step S1805). If an attached file is attached to the mail body text, the attached file data are deleted (step S1806); termination data indicating a mail delimitation are added to the picked-up data (step S1807); the picked-up data are combined with previous picked-up data (step S1808); and it is determined whether or not the processing is completed for all the mail data. If the processing is completed for all the mail data (step S1809, YES), the (combined) picked-up data are compressed (step S1810); the compressed data are divided to the data transfer size that can be transferred at one time (step S1811); numbers are assigned and added to the divided data as management information (step S1812).

At step S1804, if the transfer setting is not enabled (step S1804, NO), the processing of steps S1805, S1806 is skipped and the procedure goes to step S1807. At step S1809, if the processing is not completed for all the mail data (step S1809, NO), the processing of steps S1802 to S1809 is repeated until the processing is completed for all the mail data.

With such processing, the mail data are divided into the size that can be transferred and are enabled to be transferred.

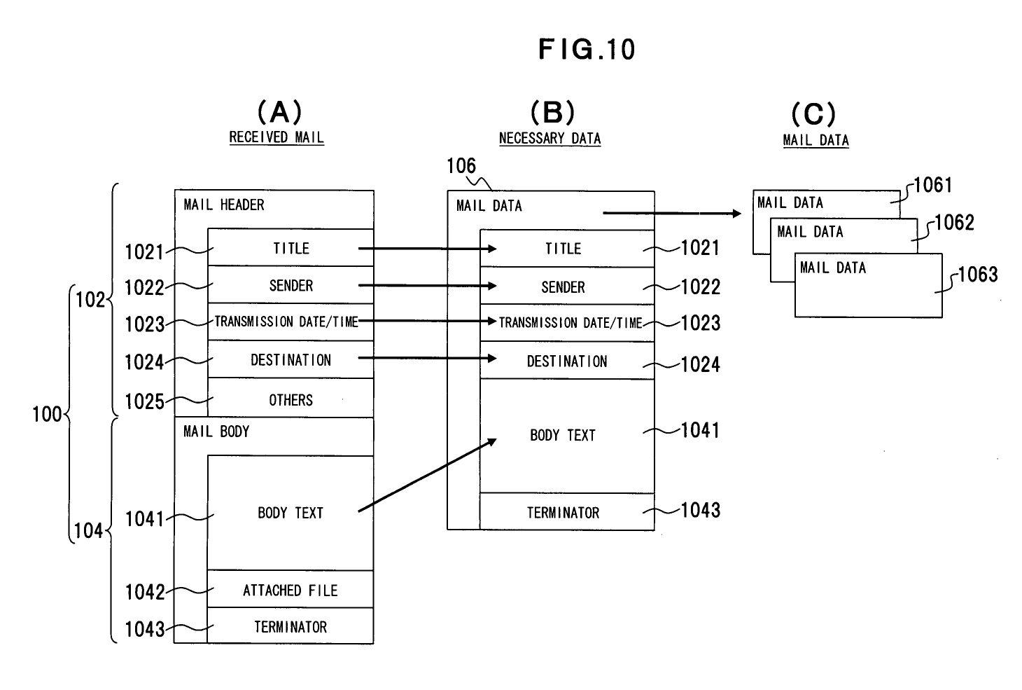

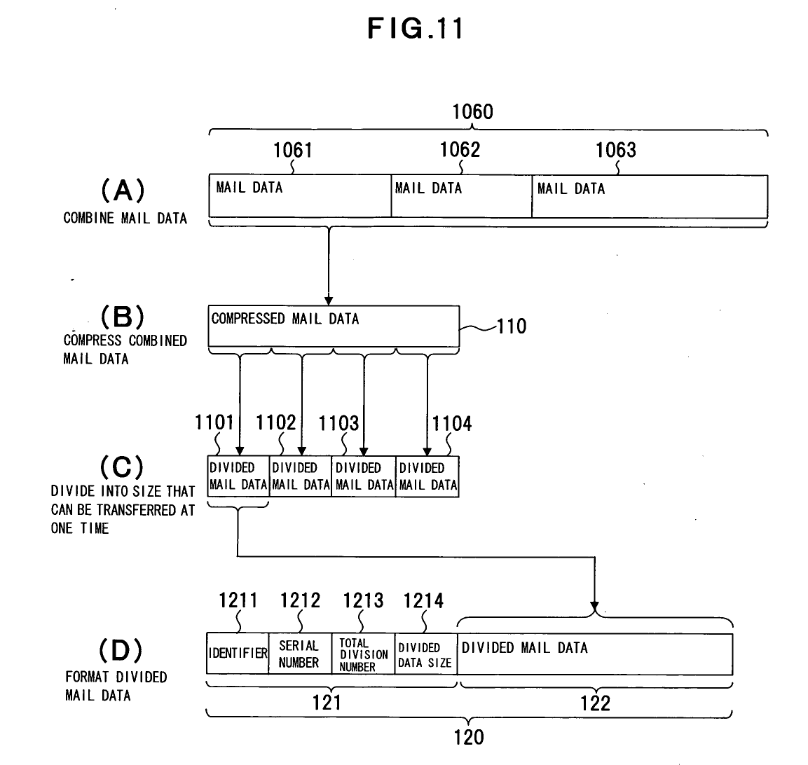

The division of the mail data will be described with reference to FIGS. 10A to 10C and FIGS. 11A to 11D. FIGS. 10A to 10C are diagrams showing the deletion processing of the unnecessary data in the mail data and FIGS. 11A to 11D are diagrams showing the division processing of the mail data.

As shown in FIG. 10A, a received mail 100 is constituted by a mail header 102 and a mail body 104 and the mail header 102 includes data of a title 1021, a sender 1022, a transmission date/time 1023, a destination 1024, and others 1025. The mail body 104 includes data of a body text 1041, an attached file 1042, and a terminator 1043.

Necessary data are picked up from this received mail 100 and, as shown in FIG. 10B, mail data 106 are obtained as the necessary data. In this case, the mail data include the title 1021, the sender 1022, the transmission date/time 1023, the destination 1024, the body text 1041, and a terminator 1043, and the others 1025 and the attached file 1042 are removed from the original data (received mail 100). In this case, the body text 1041 is added to the mail data 106 only when the transfer is enabled.

The mail data 106 correspond to mail data 1061 shown in FIG. 10C and other mail data 1062, 1063, . . . have the same configuration.

As shown in FIG. 11A, these mail data 1061, 1062, 1063 are combined as transfer data to constitute combined mail data 1060. The combination mail data 1060 are compressed to obtain compressed mail data 110, as shown in FIG. 11B.

The compressed mail data 110 are divided into the size that can be transferred at one time and, as shown in FIG. 11C, divided mail data 1101, 1102, 1103, 1104 are obtained.

The divided mail data 1101, 1102, 1103, 1104 are separately processed in format processing; as shown in FIG. 11D, one-time transfer data 120 are constituted by management data 121 and mail data 122; the management data 121 are constituted by an identifier 1211, a serial number 1212, a total division number 1213, and a divided data size 1214; and the mail data 122 are constituted by the aforementioned divided mail data 1101 (1102, 1103, or 1104).

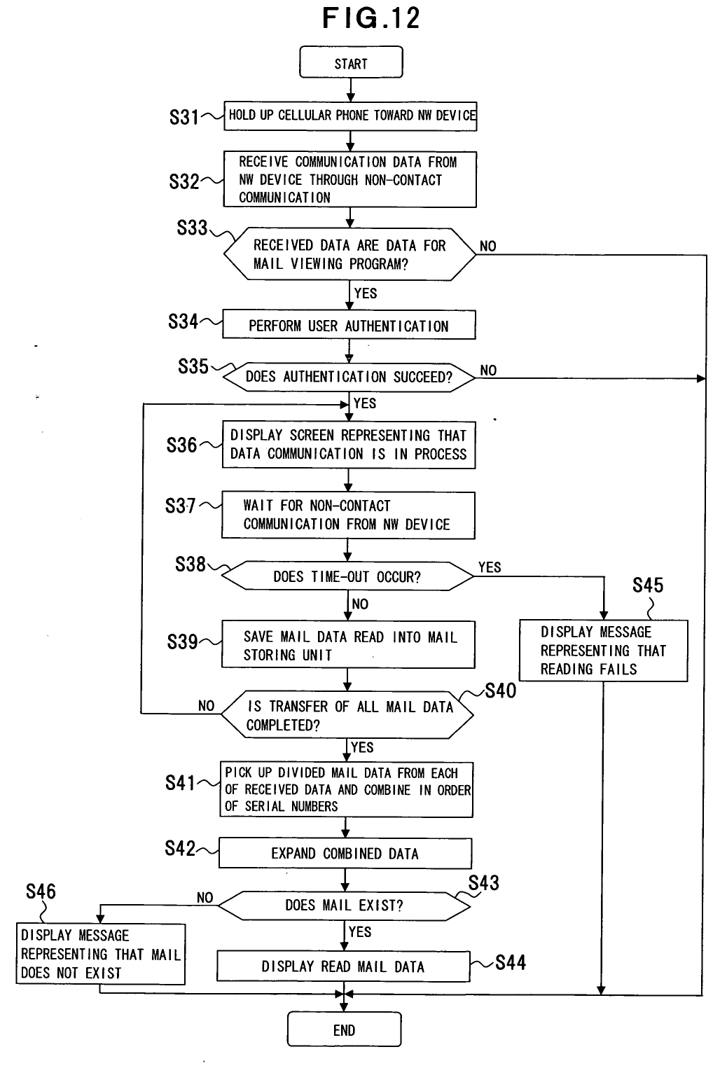

Description will be made of the data link processing of the cellular phone 12 with reference to FIG. 12. FIG. 12 is a flowchart showing the data link processing of the cellular phone 12.

To perform the non-contact communication with the NW device 10, the cellular phone 12 is directed (held up) toward the NW device 10 within the communicable area 20 of the NW device (step S31). In this way, the non-contact communication is established, and the communication data are received from the NW device 10 (step S32). It is determined whether or not the received data are data for a mail viewing program (step S33), and if the received data are data for a mail viewing program (step S33, YES), the user authentication is performed (step S34). This user authentication is performed with authentication data such as a password, biometrics, etc.; when the password authentication is performed, the password is input from the cellular phone 12; and for example, when the fingerprint authentication is performed as the biometrics authentication, a fingerprint is input from the cellular phone 12. The input authentication data are compared with the registered authentication data to identify a user.

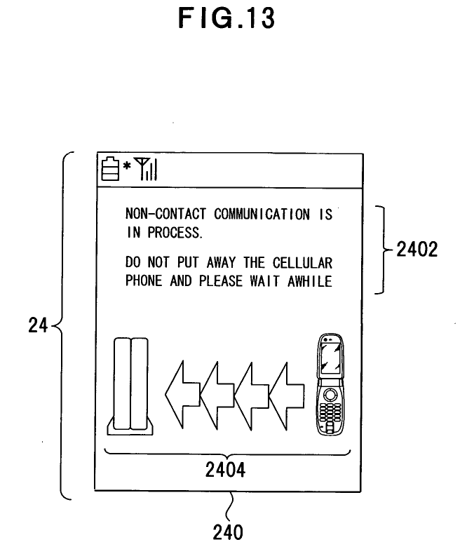

It is determined whether the authentication succeeds or not (step S35), and if the authentication succeeds (step S35, YES), for example, as shown in FIG. 13, a screen is displayed for representing that the data communication is in process (step S36) to call attention during the data communication.

While maintaining the data communication, the non-contact communication from the NW device 10 is waited (step S37); it is determined whether a time-out occurs or not (step S38); and when within a predetermined time (step S38, NO), the received mail data are saved in the mail storing unit 62 (step S39). It is determined whether the transfer of all the mail data is completed or not (step S40), and if the transfer of all the mail data is completed (step S40, YES), the divided mail data are picked up from each of the received data and are combined in the order of the serial numbers added (step S41) and the combined data are expanded (the compressed data are restored to the original data) (step S42).

It is determined whether or not a mail exists in the combined data (step S43), and if a mail exists, the read mail data are displayed on the screen displaying unit 24 (step S44) and the processing is terminated.

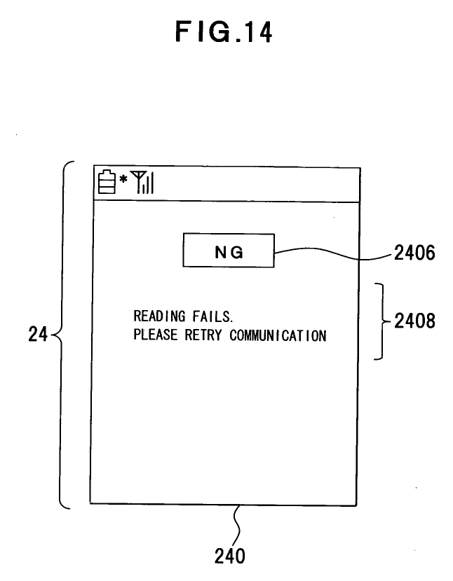

At step S33, if the mail data are not data of the mail viewing program (step S33, NO), the processing is terminated, and if the authentication does not succeed (step S35, NO), the processing is terminated. At step S38, if a time-out occurs (step S38, YES), as shown in FIG. 14, a message is displayed on the screen displaying unit 24 to represent that the reading fails (step S45) to prompt to retry the non-contact communication.

If the transfer of all the mail data is not completed (step S40, NO), the processing of steps S36 to S40 is continuously performed and the same processing is continuously performed until the transfer of the mail data is completed.

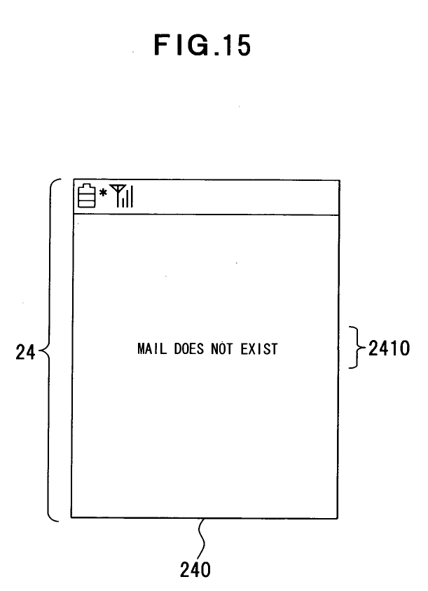

After the combined data are expanded, if a mail does not exist (step S43, NO), as shown in FIG. 15, a message is displayed on the screen displaying unit 24 to represent that a mail does not exist (step S46) and the processing is terminated.

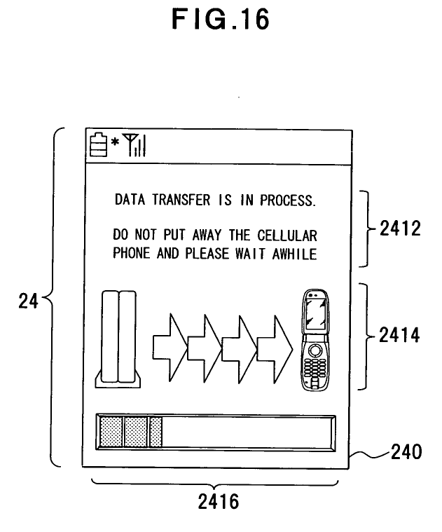

Description will be made of messages displayed on the screen displaying unit 24 with reference to FIGS. 13, 14, 15, and 16. FIG. 13 is a diagram showing a message representing that the non-contact communication is in process; FIG. 14 is a diagram showing a message notifying of a failure of data reading; FIG. 15 is a message representing whether a mail exists or not; and FIG. 16 is a diagram showing a message representing that data transfer is in process. In FIGS. 13 to 16, the same numerals are added to the same portions as FIG. 1.

During the non-contact communication, as shown in FIG. 13,

“Non-contact communication is in process. Do not put away the cellular phone and please wait a while”

is displayed on a screen 240 of the screen displaying unit 24 as a message 2402 representing that the non-contact communication is in process, along with an icon 2404 representing that the non-contact communication is in process. The icon 2404 displays the NW device 10, the cellular phone 12, and an arrow representing the transmission direction of the electric waves 18. By visually recognizing the message 2402 and the icon 2404, the user can easily recognize that the non-contact communication is in process.

If the data reading fails, as shown in FIG. 14, along with an icon 2406 notifying of the failure of the data reading,

“Reading fails. Please retry communication”

is displayed as a message 2408 on the screen 240 of the screen displaying unit 24. In this case, the icon 2406 is displayed as “NG”. By visually recognizing the icon 2406 and the message 2408, the user is prompted to retry the communication because the data reading fails.

In the processing of the transfer data, if the transfer data do not exist, for example, as shown in FIG. 15,

“Mail does not exist”

is displayed on the screen 240 of the screen displaying unit 24 as a message 2410 indicating that the transfer data do not exist. By visually recognizing the message 2410, the user can recognize that a mail does not exist.

During the data transfer, as shown in FIG. 16,

“Data transfer is in process. Do not put away the cellular phone and please wait a while”

is displayed on a screen 240 of the screen displaying unit 24 as a message 2412 representing that the data transfer is in process, along with an icon 2414 representing that the data transfer is in process and an icon 2416 representing the data accumulation. The icon 2414 displays the NW device 10, the cellular phone 12, and an arrow representing the data transmission direction of the electric waves 18, and the icon 2416 displays the accumulated amount of the data accumulation. By visually recognizing the message 2412, the icon 2414, and the icon 2416, the user can easily recognize that the data transfer is in process and is prompted to maintain the holding state without displacing the cellular phone 12.

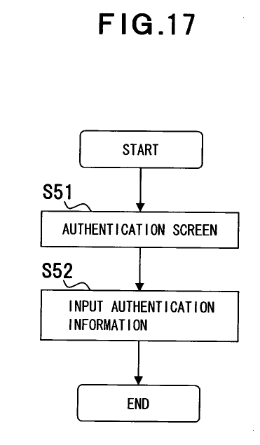

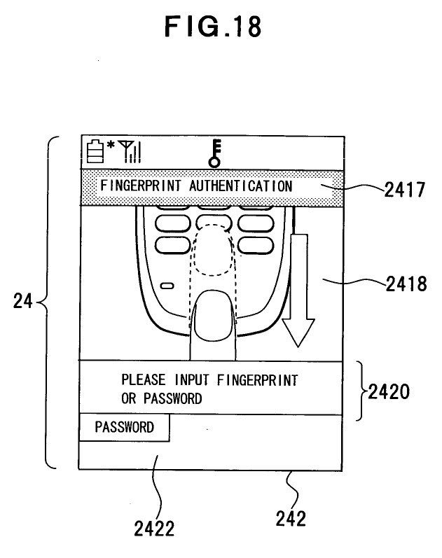

Description will be made of the user authentication processing with reference to FIGS. 17 and 18. FIG. 17 is a flowchart of the authentication processing and FIG. 18 is a diagram showing a display screen thereof.

When proceeding to the authentication processing, as shown in FIG. 18, an authentication screen 242 is displayed on the screen displaying unit 24 (step S51), and the user may input authentication data such as a password or a fingerprint as an example of the biometrics authentication in compliance with a message of the authentication screen 242 (step S52).

In this case, as shown in FIG. 18, the authentication screen 242 of the screen displaying unit 24 displays: “Fingerprint Authentication” as a message 2417; the finger operation to the fingerprint sensor 26 and the operating method thereof as an icon 2418 representing the operation; “Please input fingerprint or password” as a message 2420; and a password input area 2422 in a field under the message 2420.

The user can input a password or fingerprint as the authentication data correspondingly to the messages 2417 and the icon 2418 to perform the authentication processing.

### Other Embodiments

(1) With regard to the transfer of the divided mail data, for example,

“Divided mail data still exist in NW device”

may be displayed on the screen 240 of the screen displaying unit 24 as a message 2424, along with an icon 2426 representing the data transfer.

According to such a configuration, by visually recognizing the message 2424 and the icon 2426, the user can easily recognize that the divided mail data remain in the NW device 10 and that the data transfer is in process.

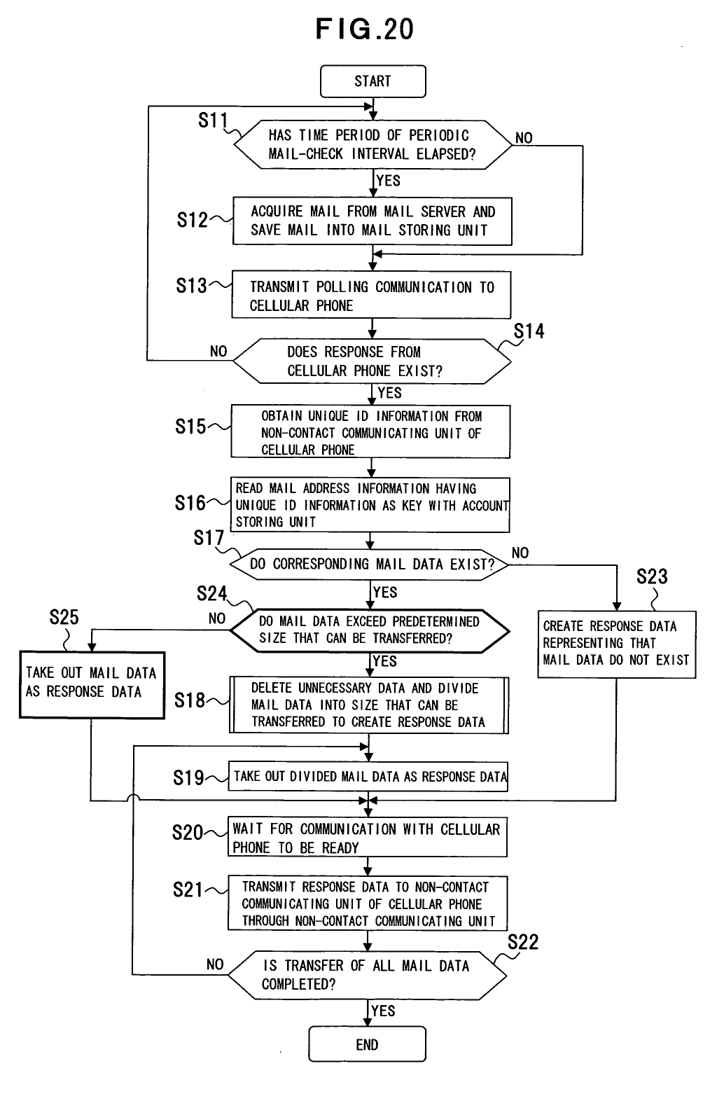

(2) With regard to the mail-data division processing, the present invention may be configured to determine the size of the mail data, as shown in FIG. 20, for example. That is, the present invention may be configured such that: at a step after step S17 of the flowchart shown in FIG. 8, it is determined whether or not the mail data exceed a predetermined size that can be transferred (step S24); if the mail data exceed the predetermined size that can be transferred (step S24, YES), the procedure goes to the mail-data division processing (step S18); and if the size of the mail data is smaller than the predetermined size (step S24, NO), the mail data are picked up as the response data (step S25) and the procedure goes to step S20.

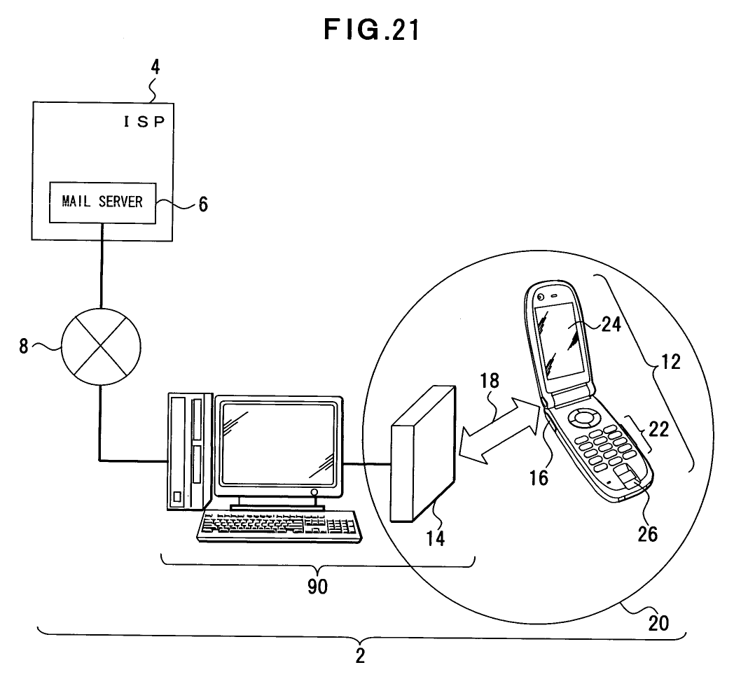

(3) As shown in FIG. 21, a personal computer 90 may be used as the NW device 10 and the present invention may be configured to connect the aforementioned non-contact communicating unit 14 to the personal computer 90. In FIG. 21, the same numerals are added to the same portions as FIG. 1 and description thereof is omitted.

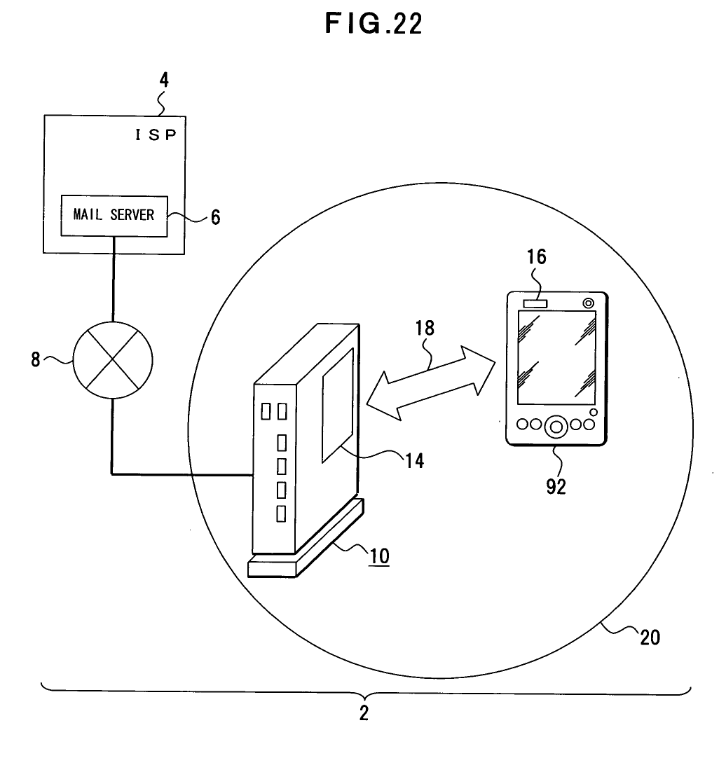

(4) As shown in FIG. 22, a personal digital assistant (PDA) 92 may be used as the communication terminal device. In FIG. 22, the same numerals are added to the same portions as FIG. 1 and description thereof is omitted.

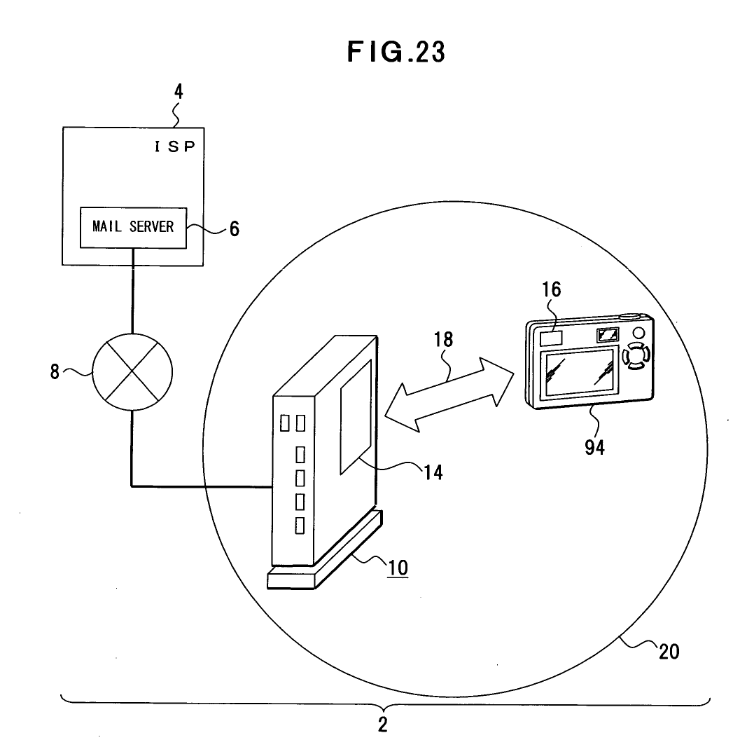

(5) As shown in FIG. 23, the present invention may be configured to use a digital camera 94 as the communication terminal device for receiving the transfer data. In FIG. 23, the same numerals are added to the same portions as FIG. 1 and description thereof is omitted.

(6) Although the above embodiments are described by taking the mail data transferred through the network 8 as an example, the present invention can be used for transferring various data other than the mail data and is not limited to the mail data.

(7) Although the fingerprint authentication is illustrated as an example of the biometrics authentication, information representing a living body may be used for the authentication, such as vein authentication.

(8) While inventive matters extracted from the above-mentioned embodiments are wide-ranging and shown in the SUMMARY or CLAIMS, further inventive matters are enumerated as follows.

To achieve the above object, there is provided a communication terminal device to which received data from network are transferred through a data transfer apparatus, the apparatus comprising a non-contact IC card into which data can be written wirelessly, wherein the received data are written by a non-contact communicating unit of the data transfer apparatus with which communication is established by the non-contact IC card.

The data transfer apparatus receives the data with the data receiving unit from the network. When the communication is established between the non-contact IC card of the communication terminal device and the non-contact communicating unit of the data transfer apparatus, the received data are written by the data transfer apparatus into the non-contact IC card of the communication terminal device and the received data are transferred.

Preferably, the communication terminal device may comprise an authentication data registering unit that registers authentication data of a user; and a controlling unit that allows the non-contact communicating unit to fetch the data if the input authentication data are identical to the registered authentication data in the authentication data registering unit.

To achieve the above object, there is provided a data transfer system that transfers received data from network, the system comprising a communication terminal device that is comprised of a non-contact IC card into which data can be written wirelessly; and a data transfer apparatus that is comprised of a non-contact communicating unit that writes data wirelessly into the non-contact IC card, the data transfer apparatus establishing communication between the non-contact IC card of the communication terminal device and the non-contact communicating unit, the data transfer apparatus writing the received data into the non-contact IC card with the non-contact communicating unit.

The data transfer apparatus receives the data with the data receiving unit from the network; the communication is established between the non-contact communicating unit of the data transfer apparatus and the non-contact IC card of the communication terminal device; the data transfer apparatus writes the received data into the non-contact IC card; and the received data are transferred.

In the data transfer system, the data transfer apparatus may be a personal computer.

Although the presently preferred embodiments of the present invention have been set forth hereinabove, it is to be appreciated that the present invention is not limited to the above description, that various modifications and alterations can naturally be achieved by those who skilled in the art based on the gist of the present invention as defined in the claims or disclosed in the specification, and that such modifications and alterations are obviously included within the scope of the present invention.

According to the present invention, data such as mail data received by a data transfer apparatus from network can be transferred to a communication terminal device by disposing non-contact IC card communication between the data transfer apparatus and the communication terminal device and various data such as mail data can be received by the communication terminal device without using a line connection such as a public line connection.

What is claimed is:

1. A data transfer apparatus that transfers received data from network, comprising:
a data receiving unit that receives data through the network; and
a non-contact communicating unit that writes the received data into a non-contact IC card of a communication terminal device equipped with the non-contact IC card into which data can be written wirelessly.

2. The data transfer apparatus of claim 1, comprising:
a transfer destination determining unit that establishes the communication between the non-contact communicating unit and the non-contact IC card to determine with authentication data received from the communication terminal device whether or not the communication terminal device is the transfer destination of the received data.

3. The data transfer apparatus of claim 1, comprising:
a processing unit that correlates registration information identifying the data transfer destination through the network with identification information identifying the communication terminal device to sort the data by the identification information.

4. The data transfer apparatus of claim 1, comprising:
a communication controlling unit that is connected to a data distribution source through the network, the communication controlling unit fetching data periodically through the network; and
a data accumulating unit that accumulates the data fetched by the communication controlling unit.

5. The data transfer apparatus of claim 1, comprising:
a data modifying unit that removes unnecessary data from the received data of the data receiving unit for modification into transfer data.

6. The data transfer apparatus of claim 1, comprising:
a data modifying unit that divides the received data of the data receiving unit into units of the size that can be transferred to the non-contact IC card for modification into the transfer data.

7. A data transferring method that transfers received data from network, comprising the operations of:
receiving data with a data receiving unit through the network;
establishing communication with a non-contact IC card into which data can be written wirelessly, the non-contact IC card being equipped in a communication terminal device of the transfer destination of the data; and
writing the received data of the data receiving unit into the non-contact IC card.

8. The data transferring method of claim 7, comprising the operations of:
establishing the communication between a non-contact communicating unit and the non-contact IC card; and
determining with authentication data received from the communication terminal device whether or not the communication terminal device is the transfer destination of the received data.

9. The data transferring method of claim 7, comprising the operation of:
correlating registration information determining the data transfer destination through the network with identification information identifying the communication terminal device.

10. The data transferring method of claim 7, comprising the operations of:
receiving data periodically from a data distribution source through the network; and
accumulating the received data.

11. The data transferring method of claim 7, comprising the operation of:
removing unnecessary data from the received data for modification into transfer data.

12. The data transferring method of claim 7, comprising the operation of:
dividing the received data into units of the size that can be transferred for modification into the transfer data.

13. A data transfer program that is executed by a computer to transfer data received through network, the ddata transfer program comprising the steps of:
receiving data through the network;
establishing communication with a non-contact IC card into which data can be written wirelessly, the non-contact IC card being equipped in a communication terminal device of the transfer destination of the data; and
writing the received data into the non-contact IC card.

14. The data transfer program of claim 13, comprising the steps of:
establishing the communication between a non-contact communicating unit and the non-contact IC card; and
determining with authentication data received from the communication terminal device whether or not the communication terminal device is the transfer destination of the received data.

15. The data transfer program of claim 13, comprising the step of:
correlating registration information determining the data transfer destination through the network with identification information identifying the communication terminal device.

16. The data transfer program of claim 13, comprising the steps of:
receiving data periodically from a data distribution source through the network; and
accumulating the received data.

17. The data transfer program of claim 13, comprising the step of:
removing unnecessary data from the received data for modification into transfer data.

18. The data transfer program of claim 13, comprising the step of:
dividing the received data into units of the size that can be transferred for modification into the transfer data.
